(19) United States
(12) Patent Application Publication
(10) Pub. No.: US 2009/0228497 A1
(43) Pub. Date: Sep. 10, 2009

(54) Patent Reference Processor

(76) Inventor: Anand Bacaji Ramakrishnan, Houston, TX (US)

Correspondence Address: Anand Ramakrishnan, 12831 Woodlite Ln., Houston, TX, 77015, US

(21) Appl. No.: 12/041,717

(22) Filed: Mar. 4, 2008

(51) Int. Cl. G06F 17/30

(52) U.S. Cl. 707/100; 707/E17.009

(57) ABSTRACT

Embodiments of the present invention provide techniques for extracting reference number, reference name pairs from prior art. The extraction may occur by finding the reference numbers of prior art that has been converted to a data stream and then searching within the vicinity of the found reference number for the reference name.

### BACKGROUND OF THE INVENTION

1. Field of the Invention

Embodiments of the present invention generally relate to processing of information in text.

2. Description of the Related Art

The ability to parse and process information is becoming increasingly important as more and more information is becoming available online. Within the realm of patent law, for example, the parsing of information within a patent is useful in its prosecution. The parsing of information in a patent application may also be useful.

For example, many times Examiners may refer to elements within patents or patent pulications cited as prior art by their reference numbers. These numbers must generally be looked up in the cited art. Of proper analysis of the art, it is useful to label the drawings of cited art with their name in the patent. For instance, if FIG. 1 of a patent has an element or item named a circuit labeled “1000,” it may be useful to label on the drawing or have easy access to the name “circuit 1000” as it is referred to in the patent. The same may be true for any prior art document.

A technique is needed to extract these reference numbers from a document.

### BRIEF DESCRIPTION OF THE DRAWINGS

So that features of the present invention can be understood in detail, a particular description of the invention may be had by reference to embodiments, some of which are illustrated in the appended drawings. It is to be noted, however, that the appended drawings illustrate only typical embodiments of this invention and are therefore not to be considered limiting of its scope, for the invention may admit to other equally effective embodiments.

FIG. 1 is a view of a computer system according to an embodiment of the present invention.

FIG. 2 is a flow chart of example operations for storing reference names and reference numbers.

FIG. 3 is a view of an example hard drive configuration to an embodiment of the present invention.

FIG. 4 is a view of an example hard drive configuration according to an embodiment of the present invention.

### DETAILED DESCRIPTION OF THE PREFERRED EMBODIMENTS

Embodiments of the present invention provide techniques for extracting reference number, reference name pairs from prior art. The extraction may occur by finding the reference numbers of prior art that has been converted to a data stream and then searching within the vicinity of the found reference number for the reference name. Reference number, reference name pairs may be in the same vicinity of the data stream and therefore finding the reference numbers first may be advantageous given that, for example, most patents reference elements in a predictable manner (see “circuit 1000” example above).

### Example Computer System

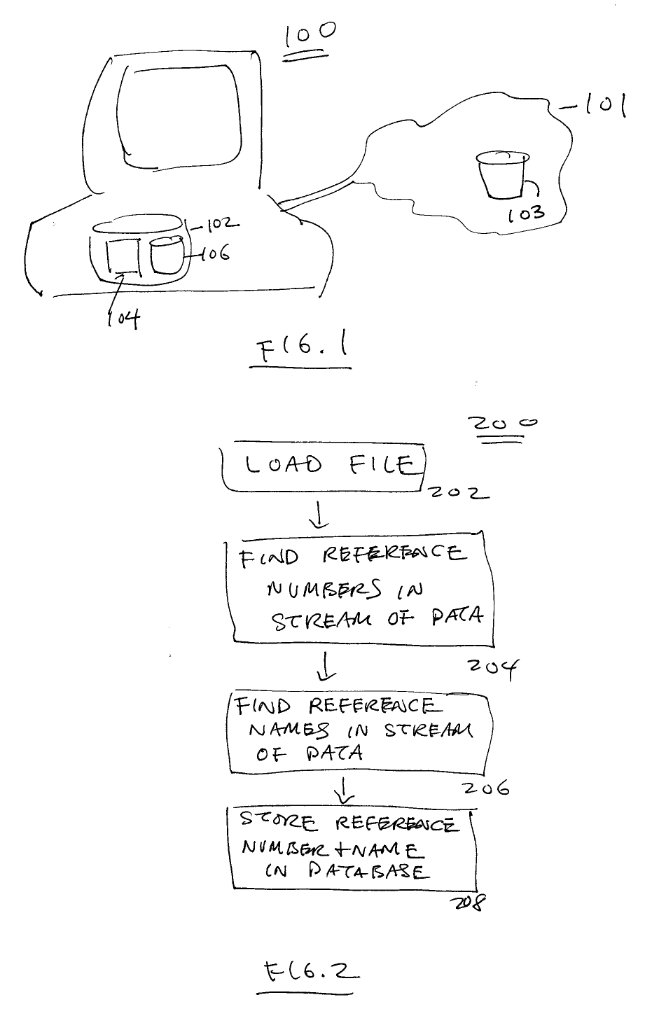

FIG. 1 illustrates an example system 100 in which the embodiments of the present invention may be utilized. The computer 100 may contain a text file 104 that is stored on a database 106. The database 106 may be stored on a hard drive 102. The text file 104 may have been stored on a database 103 somewhere in a connected network 101. The computer 100 may be connected to a network of 101 that may have another database 103. The text file 104 may have been stored on the database 103 and may have been downloaded to the database 102. The database 103 may be on a webserver.

FIG. 2 illustrates example operations 200 for storing reference numbers and names. At 202, a file may be loaded into the computer's memory as a data stream. The file may be a representation of prior art such as a text file representing the text of a patent or a patent application. The file may have been loaded from another database or hard drive such as 103. The file may be stored somewhere in the hard drive. In some embodiments, the data streaming may be stored on the hard drive 102 as a data stream 302 described below.

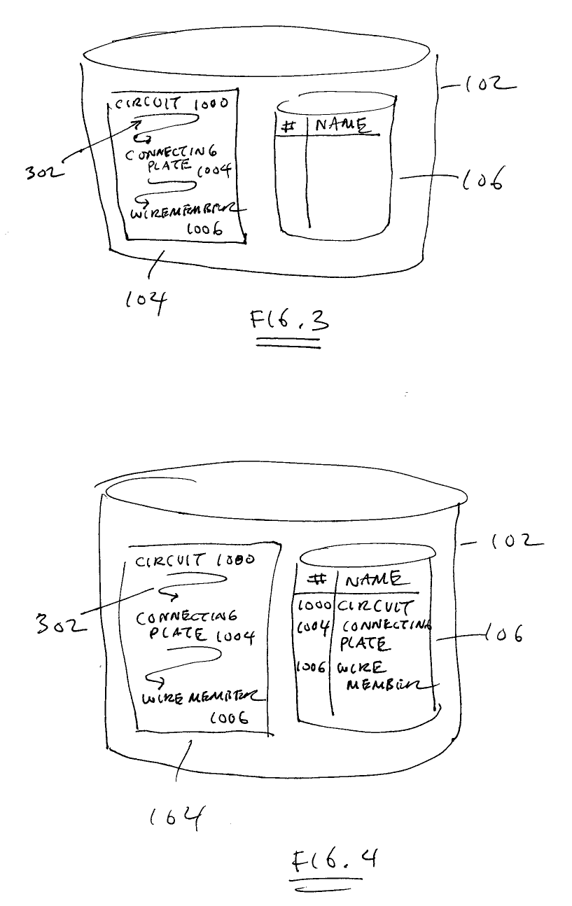

FIG. 3 illustrates an example hard drive configuration according to an embodiment of the invention. The text file 104 may be loaded as a data stream 302 into a hard drive 102. A database 106 may be stored on the hard drive 102. The reference numbers 1000, 1004, and 1006 may be located within the data stream 302 of the text file 104. In some embodiments, the data stream 302 may be parsed by a regular expression parser that searches for numbers within the data stream 302. A regular expression parser may be a PERL language regular expression.

At 202, a file may be loaded into memory. At 206, the computer may find reference names in the stream of data. The reference names may be found using relative positions of found reference numbers. In some embodiments, the reference names may be found by looking at the words before the position of found reference numbers in the data stream. In some embodiments, the reference names may be found by looking at a fixed number of positions before the found reference numbers in the data stream. In some embodiments, the reference names may be found by looking at a variable number of positions before the found reference numbers in the data stream based on an analysis of a chunk of words found before the reference numbers in the data stream. The number of positions looked at before may be a result of the comparison of previous occurrences of the same reference number and reference name. For example, if “second signal circuit 105” was found previously in the data stream, then the at the next occurrence of 105 in the data stream, we would know to look three words ahead for “second signal circuit 105” and not just “circuit 105.” This may avoid creating a “circuit, 105” pair, rather than a “second signal circuit, 105” pair.

At 208, the computer stores the reference number, reference name pairs in a database. The database may be a listing in another text file in a hard drive. The pair may be associated with each other in some form rather than the pairs being in a database in some embodiments. The pairs may be stored in a database 106 as described below.

FIG. 4 illustrates an example hard drive configuration according to an embodiment of the invention. The database 106 may store the reference number, reference name pairs. Each reference name such as “circuit” is stored with its corresponding reference number such as “1000.” This pairing provides the benefits described above.

While the foregoing is directed to embodiments of the present invention, other and further embodiments of the invention may be devised without departing from the basic scope thereof, and the scope thereof is determined by the claims that follow.

1. (canceled)

2. (canceled)

3. (canceled)

4. A method comprising:
Loading a data structure into memory into a computer from a network comprising at least one data structure;
Viewing a portion of the data structure according to a factor where the factor is a value that may be searched for in the data structure according to search parameters that may be varied according to a user inputted value that determines a bottom portion and a top portion of the portion;
Finding another portion of the data structure according to a pattern in the data structure where the pattern may be varied;
Finding a second another portion of the data structure which references to the portion of the data structure and the another portion of the data structure that may be varied according to a user inputted value; and
Saving the portion of the data structure, the another portion of the data structure, and the second another portion of the data structure and the respective spatial relationships between the data structure the another portion of the data structure, and the second another portion of the data structure.

5. The method of claim 4, wherein the value that is searched for in the data structure according to search parameters is a value searched for according to regular expression search parameters.

6. The method of claim 5, wherein the finding of another portion of data occurs by looking ahead of the viewed portion of the data structure.

7. The method of claim 5, wherein the finding of another portion of data according to a pattern comprises looking ahead of the viewed portion of the data structure.

8. The method of claim 5, wherein the finding of another portion of data comprises looking ahead a fixed number of positions of the viewed portion of the data structure.

9. The method of claim 5, wherein the finding of another portion of data comprises looking at a previous another portion of the data structure.

10. The method of claim 5, wherein only the second another portion of the data structure is saved,

11. The method of claim 5, wherein the second another portion comprises one or more words relating to the viewed portion of the data structure.

12. An apparatus comprising:
A means for loading a data structure into memory into a computer from a network comprising at least one data structure;
Processing logic for viewing a portion of the data structure according to a factor where the factor is a value that may be searched for in the data structure according to search parameters that may be varied according to a user inputted value that determines a bottom portion and a top portion of the portion;
A means for finding another portion of the data structure according to a pattern in the data structure where the pattern may be varied;
A means for finding a second another portion of the data structure which references to the portion of the data structure and the another portion of the data structure that may be varied according to a user inputted value; and
Processing logic for saving the portion of the data structure, the another portion of the data structure, and the second another portion of the data structure and the respective spatial relationships between the data structure the another portion of the data structure, and the second another portion of the data structure.

13. The method of claim 12, wherein the value that is searched for in the data structure according to search parameters is a value searched for according to regular expression search parameters.

14. The method of claim 12, wherein the finding of another portion of data comprises looking ahead a fixed number of positions of the viewed portion of the data structure.

15. An apparatus comprising:
Processing logic for loading a data structure into memory into a computer from a network comprising at least one data structure and
Viewing a portion of the data structure according to a factor where the factor is a value that may be searched for in the data structure according to search parameters that may be varied according to a user inputted value that determines a bottom portion and a top portion of the portion and
Finding another portion of the data structure according to a pattern in the data structure where the pattern may be varied and
Finding a second another portion of the data structure which references to the portion of the data structure and the another portion of the data structure that may be varied according to a user inputted value and
Saving the portion of the data structure, the another portion of the data structure, and the second another portion of the data structure and the respective spatial relationships between the data structure the another portion of the data structure, and the second another portion of the data structure.

16. The apparatus of claim 15, wherein the value that is searched for in the data structure according to search parameters is a value searched for according to regular expression search parameters.

17. The apparatus of claim 15, wherein the finding of another portion of data occurs by looking ahead of the viewed portion of the data structure.

18. The apparatus of claim 15, wherein the finding of another portion of data according to a pattern comprises looking ahead of the viewed portion of the data structure.

19. The apparatus of claim 15, wherein the finding of another portion of data comprises looking ahead a fixed number of positions of the viewed portion of the data structure.

20. The apparatus of claim 15, wherein the finding of another portion of data comprises looking at a previous another portion of the data structure.

21. The apparatus of claim 15, wherein only the second another portion of the data structure is saved.

22. The apparatus of claim 15, wherein the second another portion comprises one or more words relating to the viewed portion of the data structure.

23. A method comprising:
Loading a data structure into memory into a computer from a network comprising at least one data structure;
Viewing a portion of the data structure according to a factor where the factor is a value that may be searched for in the data structure according to search parameters that may be varied according to a user inputted value that determines a first portion and a second portion of the portion;
Finding another portion of the data structure according to a pattern in the data structure where the pattern may be varied;
Finding a second another portion of the data structure which references to the portion of the data structure and the another portion of the data structure that may be varied; and
Saving the portion of the data structure, the another portion of the data structure, and the second another portion of the data structure and the respective relationships between the data structure the another portion of the data structure, and the second another portion of the data structure.

24. A method comprising:
Loading a data structure into memory into a computer from a network comprising at least one data structure;
Viewing a portion of the data structure according to a factor where the factor is a value that may be searched for in the data structure according to search parameters including one or more regular expressions that may be varied according to a user inputted value that determines a bottom portion and a top portion of the portion;
Finding another portion of the data structure according to a pattem in the data structure where the pattern may be varied;
Finding a second another portion of the data structure which references to the portion of the data structure and the another portion of the data structure that may be varied according to a user inputted value; and
Saving the portion of the data structure, the another portion of the data structure, and the second another portion of the data structure and the respective relationships between the data structure the another portion of the data structure, and the second another portion of the data structure.

25. A method comprising:
Loading a data structure into memory into a computer from a network comprising at least one data structure;
Viewing a portion of the data structure according to a factor where the factor is a value that may be searched for in the data structure according to search parameters that may be varied according to a user inputted value that determines a bottom portion and a top portion of the portion;
Finding another portion of the data structure according to a pattern in the data structure;
Finding a second another portion of the data structure according to one or more regular expressions which references to the portion of the data structure and the another portion of the data structure that may be varied according to a user inputted value: and
Saving the portion of the data structure, the another portion of the data structure, and the second another portion of the data structure and the respective spatial relationships between the data structure the another portion of the data structure, and the second another portion of the data structure.
